(19) United States
(12) Patent Application Publication
(10) Pub. No.: US 2002/0121027 A1
(43) Pub. Date: Sep. 5, 2002

(54) Apparatus and method for spacing tiles

(76) Inventor: Stephen L. Kruskamp, Fair Oaks, CA (US)

Correspondence Address: MEDLEN & CARROLL, LLP, 101 HOWARD STREET, SUITE 350, SAN FRANCISCO, CA, 94105, US

(21) Appl. No.: 09/800,297

(22) Filed: Mar. 5, 2001

(51) Int. Cl. G01B 3/30

(52) U.S. Cl. 33/526; 33/645

(57) ABSTRACT

A tile spacer is provided which can be used to create consistent gaps between tiles in a tile floor installation. The spacer is in the form of a cross having a center and four arms extending outwardly from said center with each arm positioned at an angle of about ninety degrees from each adjacent arm, and each arm has a predetermined width for forming a space of desired width between adjacent tiles placed on a substantially flat, adhesive-coated surface which will be subsequently filled with grout, and a groove of predetermined shape connecting the diagonally opposed intersections between the arms forms a raised bead in the adhesive for providing further support for the tiles and grout once the adhesive cures. The shape of the tile spacer allows it to be used between adjacent tiles in the first course of tiles laid along a chalk line or straight edge, as well as in the intersections formed between each group of four tiles as subsequent courses of tiles are laid, and a handle allows easy subsequent removal once the adhesive has set or cured.

### TECHNICAL FIELD OF THE INVENTION

This invention relates generally to floor and wall installation, and more particularly to the construction of tiled floors and walls.

### BACKGROUND OF THE INVENTION

Tiles have been used since ancient times to produce decorative and highly attractive floors and walls. Tiles are also quite useful in producing surfaces which are waterproof or highly water-resistant, and easy to clean, and therefore very desirable for bathrooms and kitchens.

Some of the most beautiful tile work is formed from irregular pieces of tile or glass set by hand by artists to form mosaics of incredible detail. However, such works are very time consuming to produce, and are therefore well beyond the means of most consumers. Accordingly, most tile floors and walls are installed as quickly as possible, using standard rectangular tiles. Not infrequently, consumers themselves will attempt tile installation with little or no prior instruction to keep costs down.

Tile installation is fairly straight forward. The surface to be tiled is cleaned to remove any bumps or surface irregularities, so that a substantially clean, flat surface is produced. The surface is coated with a slow-curing adhesive composition, referred to in the trade as “mud.” A straight edge, chalk line or laser is used at one edge of the surface for aligning the first row of tiles, then the remaining tiles are aligned with respect to the first row of tiles. When it is desired to shift Each tile is spaced away from each adjacent tile by a desired gap. Once the mud is cured, the gap between the tiles is filled with grout. When complete, the lines of grout most desirably produce straight lines of consistent width. Getting the tiles aligned so that the grout in the finished installation is straight and of consistent width is clearly the most difficult and time consuming task, and is the most frequent cause of a poor or unacceptable looking tile installation.

Accordingly, the need exists for a tile spacer which can be used with ease by a skilled worker or an amateur to produce a tiled floor or wall which looks like a professional installation.

### SUMMARY OF THE INVENTION

In one embodiment, the present invention provides a spacer for aligning tiles with respect to each other, the spacer having a spacer body and a handle for pushing the spacer body into, and removing the spacer body from, the gap between adjacent tiles, the spacer in the form of a cross of predetermined thickness made from a material sufficiently rigid to prevent substantial deformation by the tiles, the cross having a center and four arms extending outwardly from the center, each arm positioned at an angle of substantially ninety degrees from each adjacent arm, each said arm having a predetermined width equal to the desired spacing between adjacent tiles, each said arm having a bottom surface with a substantially flat portion for engaging the substantially flat surface to be tiled, each said arm also having a first side surface in a plane perpendicular to the bottom surface and a second side surface opposite said first side surface also in a plane perpendicular to the bottom surface, the first and second side surfaces having a substantially flat portion for engaging and aligning the facing edges of adjacent tiles.

In yet another embodiment, the present invention provides a spacer for aligning tiles with respect to each other, the spacer having a spacer body in the form of a cross of predetermined thickness made from a material sufficiently rigid to prevent substantial deformation by the tiles, the cross having a center and four arms extending outwardly from the center, each arm positioned at an angle of substantially ninety degrees from each adjacent arm, each said arm having a predetermined width equal to the desired spacing between adjacent tiles, each said arm having a bottom surface with a substantially flat portion for engaging the substantially flat surface to be tiled, and a groove connecting diagonally opposed intersections between adjacent arms through said center for forming a raised bead of predetermined shape in an adhesive layer in which the tiles are laid during the construction of the tile floor. A handle may be provided to permit easy insertion and removal of the spacer, and manipulation of the tiles while the adhesive remains workable.

In yet another embodiment, the present invention includes a method for installing tiles using a tile spacer of the present invention;

In yet another embodiment, the present invention includes a point of sale display for displaying a variety of different sizes of tile spacers to consumers who wish to attempt a tile floor installation without professional assistance, the tile spacers being color coded so that consumers can select the tile spacer which will produce the desired spacing between adjacent tiles by selecting tile spacers of the correct color.

Other and further objects, features, advantages and embodiments of the present invention will become apparent to one skilled in the art from reading the Detailed Description of the Invention together with the drawings.

### BRIEF DESCRIPTION OF THE DRAWINGS

FIG. 1 is a perspective top view of a tile spacer of the present invention;

FIG. 2 is a perspective bottom view of a tile spacer of the present invention.

FIG. 3 is a side view of a tile spacer of the present invention;

FIG. 4 is a cross-section taken through line 4-4 of FIG. 3;

FIG. 5 is a cross-section taken through line 5-5 of FIG. 3;

FIG. 6a is a top view of a tile installation showing the use of tile spacers of the present invention to create uniformly even spacing between tiles;

FIG. 6b is a top view of a tile installation showing the use of tile spacers of the present invention to create one width of spacing between tiles in one direction and a second, different width of spacing between tiles in a perpendicular direction; and,

FIG. 7 is a front view of a consumer display showing a preferred method of displaying for sale tile spacers of the present invention.

### DETAILED DESCRIPTION OF THE INVENTION

A tile spacer of the present invention is used to provide accurate spacing between tiles in a tile floor construction formed by laying the tiles in a layer of adhesive, and, once the adhesive has set or cured, adding grout to a level flush or substantially so with the top surface of the tile. The term “adhesive” as used herein means any adhesive composition used to lay tile, such as, for example, thin set, mortar or mastic.

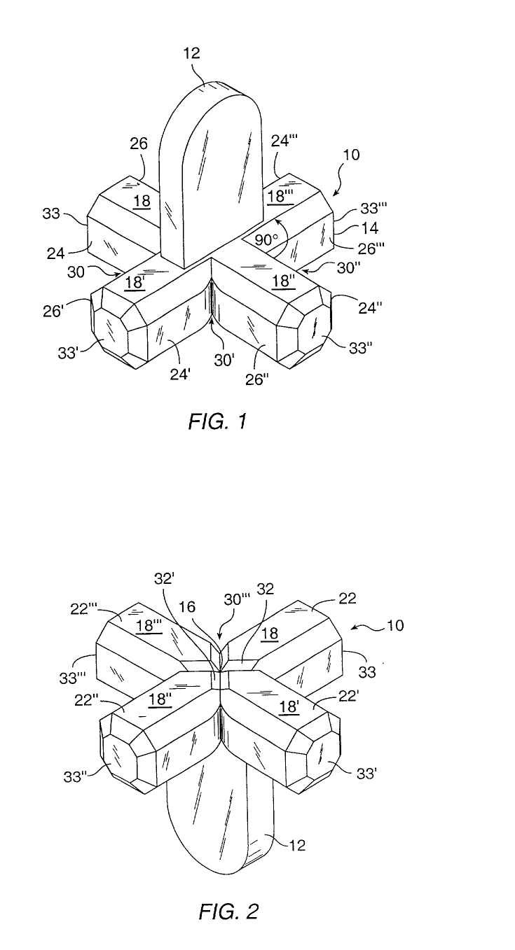

As shown in FIGS. 1-5, a tile spacer of the present invention preferably comprises a spacer body 10 and a handle 12. Spacer body 10 is in the form of a cross of predetermined thickness or height 14 which will enable the handle 12 to extend above the surface of the tiles when the spacer body 10 is inserted between adjacent tiles during installation of a tile floor or wall. Handle 12 also allows the installer to shift and move tiles which may have become misaligned to place them in more accurate alignment while the adhesive is still wet or workable. The spacer body 10 and handle 12 are most preferably formed as a single piece, for example, by molding or machining. However, it would also be possible to form the spacer body 10 with a connector or other engagement means which would permit a handle 12 to be removably connected to the spacer body 10.

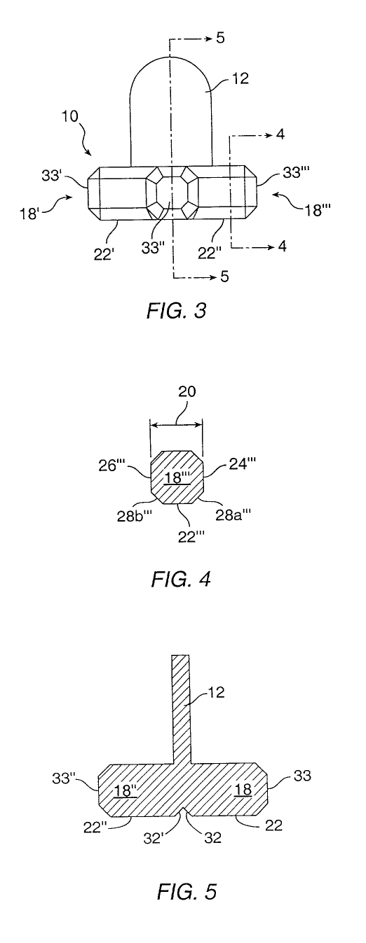

Spacer body 10 has a center 16 and four arms 18, 18′, 18″, 18′″ which extend outwardly from center 16 with each arm positioned at an angle of about ninety (90) degrees from each adjacent arm. Each arm 18, 18′, 18″, 18′″ has a substantially flat bottom surface 22, 22′, 22″, 22′″ for engaging a layer of adhesive on a substantially flat surface to be tiled. In addition, each arm has an end surface 33, 33′, 33″, 33′″, a first side surface 24, 24′, 24″, 24′″ and a second side surface 26, 26′, 26″, 26′″. First side surfaces 24, 24′, 24″, 24′″ and second side surface s 26 , 26′, 26″, 26′″ include at least a portion which is substantially flat for engaging and aligning the flat edges of the tiles during installation. While the arms 18, 18′, 18″, 18′″ may be generally rectangular in cross-section, they are more preferably bevelled as shown most clearly in FIGS. 3 and 4, to provide guiding surfaces to enable the tile spacer to easily slide into place past rigid, sharp tile edges during installation and to force apart adjacent tiles which are spaced too closely together. The bevelled surfaces preferably include surfaces between each bottom surface and adjacent side surfaces, such as, for example, bevelled surface 28a′″ between the bottom surface 22′″ and first side 24′″ and bevelled surface 28b′″ between bottom surface 22′″ and second side 26′″ shown in FIG. 4. The end of each arm 18, 18′, 18″, 18′″ may also be bevelled as shown in FIG. 5.

A shaped groove 32, 32′ (preferably “v” or “u” shaped groove), shown in FIGS. 2 and 5, is also most preferably provided to connect diagonally opposed intersections between the arms 18, 18′, 18″, 18′″. This produces a raised, shaped bead of adhesive between the tiles which provides an additional molded structure which more readily holds the tiles and prevents their displacement prior to grouting, and also provides an additional molded structure for securely holding the grout.

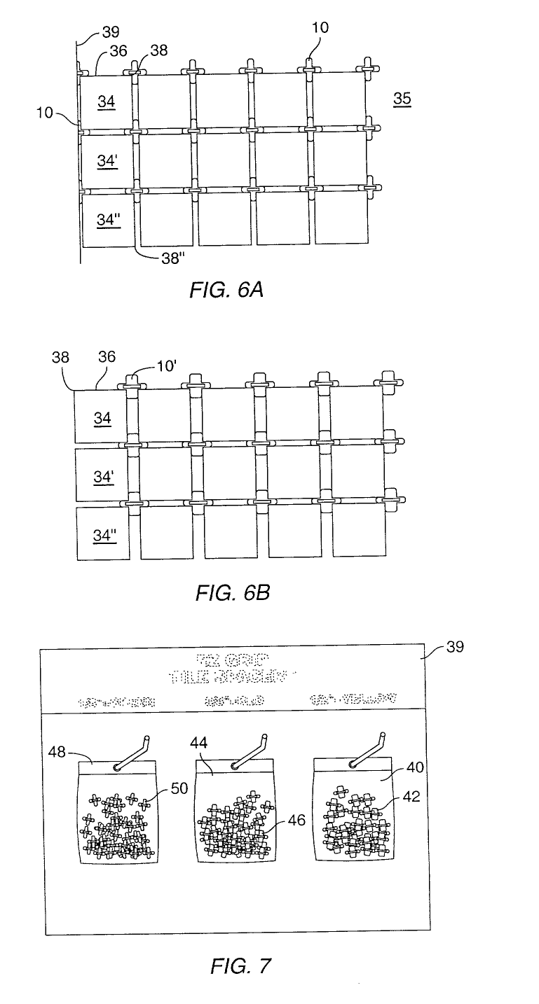

It will be immediately apparent that the distance between the first and second side surface of each arm defines the width 20 of each arm (see, for example, FIG. 4). Width 20 sets the spacing between adjacent tiles which will subsequently filled with grout. The desired spacing between adjacent tiles will vary from installation to installation, and will depend, in large part, on the personal preferences of the installer or consumer, and on the size of the tiles to be installed. Generally, larger spacing is desirable for larger tiles, and smaller spacing for smaller tiles. Therefore, the size of a tile spacer of the present invention, and more importantly, of the width 20 of the arms of a tile spacer of the present invention, may be modified to produce predetermined spaces of a variety of sizes which will be suitable for a wide range of different size tiles. While most consumers appear to prefer that the predetermined space between tiles be a consistent size throughout the installation, it is possible that some consumers might wish for the grout to form horizontal lines of one thickness and vertical lines of a different thickness. For such an installation it would, of course, be possible to provide a tile spacer having a first arm thickness for two arms aligned along a common axis, and a second arm thickness for the remaining two arms which are perpendicular. The use of such a spacer would, of course, be slightly more complex for an amateur to use, since it would require the amateur to orient the spacer correctly before inserting it between adjacent tiles. For an example of such an installation, see FIG. 6b.

The intersection 30, 30′, 30″, 30′″ between the arms, shown in FIGS. 1 and 2, preferably do not form rigid ninety (90) degree angles, but are slightly radiused (or cut away) to form a concavity to avoid any interference with the sharp corner of a tile so that the intersection can be easily slipped over the sharp corner of a tile as the tile spacer is used to adjust the spacing between adjacent tiles.

A tile spacer of the present invention is preferably made of a material which is sufficiently rigid to avoid deformation when pressed between adjacent tiles, and sufficiently smooth to allow the surfaces of the tile spacer to contact and easily slide past the relatively rough surface edges of the tile. Acceptable materials include injection molded stiff silicone, plastic, ceramic, glass, or metals such as steel or aluminum. I particularly prefer injection molded silicone which can be provided in a variety of different colors for color coding different sizes of tile spacers. Moreover, it is preferred that the spacer body 10 and handle 12 be cast as a single, unitary structure. This prevents the handle 12 becoming inadvertently detached during removal of the tile spacer body 10 after the tile structure has been completely installed and during or after curing of the adhesive composition or “mud”.

To use tile spacer of the present invention, one first determines the width of the space which is desired between the adjacent tiles of the installation, based upon personal preference and the size of the tile being installed, and selects tile spacers having a spacer arm width 20 which will produce the desired space. First, the surface 35, shown in FIG. 6a, to be tiled is cleaned and irregularities removed to produce a substantially flat and clean surface. Next, an adhesive composition is used to coat the surface to be tiled. The adhesive should have a sufficiently long cure time to allow the tile to be laid and adjusted as necessary. A first “course” or line of tiles 34, 34′, 34″ is laid and aligned, usually to a chalk line 39 or a laser beam generated by an electronic alignment device, or by a straight edge. A single arm of a tile spacer 10 of the present invention can be used to accurately create the correct sized space between, for example, adjacent tiles 34, 34′ in this first course by simply pushing one arm down into the gap, between tiles 34, 34′, so that two of the other arms span the top surface of the adjacent tiles, the bottom surface of tile spacer 10 is oriented towards the chalk line 39, the handle of tile spacer 10 bridges the top surface of both tiles 34, 34′, and one arm extends upwards to provide a lever for removing the tile spacer 10 after all the tiles are installed. When the second and subsequent courses are laid, a tile spacer 10 is inserted at the intersection between each adjoining group of four tiles, so that one arm extends into the space between each two adjacent tiles of the four, to provide for automatic alignment of each end of the tile. Thus, as each course of tile is laid, use of the tile spacer 10 at the corners provide automatic alignment with the last course of tile laid. Accordingly, if the first course is carefully laid with respect to the chalk line, all remaining courses will be correct and aligned precisely. If it becomes necessary to adjust the first course slightly, this can be done with a straight edge. Since the handle or arm of a tile space 10 of the present invention provides a substantially flat surface, a straight edge may, if desired, be used to bear against all of the handles of the facing tile spacers to shift all or a plurality of tiles in the first course. When the adhesive composition cures, or when it has set up sufficiently to hold the tile in place, the tile spacers may be removed by simply pulling them out using the handle 12, or, in the case of the tile spacers used to space the tiles in the first course, by pulling up on the arm which extends upward. To finish the job, the installer need only fill the space between the tiles with grout.

Because of the wide variety of tile sizes and styles available to the consumer, it will be necessary to offer tile spacers of the present invention in a variety of arm widths to produce a corresponding variety of predetermined space widths between the tiles. To make it easy for the consumer to select a desired arm width, I prefer to produce each different size tile spacer in a different color. Of course, it would be possible to paint the tile spacers to give them the proper color; however, as noted above, I prefer to produce the tile spacers from an injection molded stiff silicone which is available in wide variety of colors, so that the dimensions of the tile spacers will not be changed by adding a coating and so that the color cannot be inadvertently rubbed or worn off. Thus, for example, a spacer having a ⅛ inch arm width might be green, while a spacer having a ⅜ inch arm width might be red, and a spacer having a ½ inch arm width might be yellow. Such color coding will prevent mix-ups at the production facility, since it will be easy for quality control to visually spot a spacer which does not belong in a particular batch. Moreover, a plurality of like-colored spacers can be packaged and sold in clear plastic bags or other packaging through which consumers can see the color of the spacers. A point of sale display, including a rack or shelves for displaying the different packages of spacers, can also include a color chart showing the different sizes and their colors to provide immediate instructions to assist the consumer in choosing the right package.

One skilled in the art will recognize at once that it would be possible to construct the present invention from a variety of materials and in a variety of different ways. While the preferred embodiments have been described in detail, and shown in the accompanying drawings, it will be evident that various further modification are possible without departing from the scope of the invention as set forth in the appended claims.

What is claimed is:

1. An apparatus for spacing tiles during construction of a tile floor or wall, the apparatus comprising:
a spacer body in the form of a cross of predetermined thickness made from a material sufficiently rigid to prevent substantial deformation by the tiles, said cross having a center and four arms extending outwardly from said center, each arm positioned at an angle of substantially ninety degrees from each adjacent arm, each said arm having a predetermined width equal to a desired spacing between adjacent tiles, each said arm having a bottom surface for engaging the surface to be tiled, each said arm also having a first side surface extending upwards away from a first edge of said bottom surface at an angle of about 90 degrees and a second side surface extending upwards away from an opposite side of said bottom surface at an angle of about 90 degrees, said first and second side surfaces having a substantially flat portion for engaging and aligning an edge of a tile; and
a handle extending away from a top surface of said spacer of sufficient size to be gripped by two or more fingers of a user for inserting the spacer between two or more tiles laid adjacent to one another.

2. The apparatus of claim 1 wherein an intersection between said bottom surface and each said side surface is beveled to enable each arm to slip easily into place past sharp edges of adjoining tiles.

3. The apparatus of claim 1 wherein an intersection between each adjacent arm is radiused to provide a concave surface to allow the intersection to be slipped easily over a sharp corner of a tile substantially without interference.

4. The apparatus of claim 1 wherein said handle and spacer are made from the group consisting of silicone, plastics, metals, or ceramics.

5. The apparatus of claim 4 wherein said handle and spacer are formed as a unitary structure by molding.

6. The apparatus of claim 1 wherein the spacer body and handle are color coded to identify the predetermined width of each arm.

7. The apparatus of claim 1 wherein the predetermined width of any one arm is substantially identical to the predetermined width of the other arms of the spacer.

8. The apparatus of claim 1 wherein the predetermined width of any two arms aligned along a common axis is different from the predetermined width of the two remaining arms.

9. The apparatus of claim 1 wherein an end of each arm is bevelled.

10. The apparatus of claim 1 wherein said bottom surface is substantially flat.

11. A method for installing tiles on a substantially flat surface, said method comprising the steps of:
covering the substantially flat surface to be tiled with an adhesive composition for bonding the tiles to the substantially flat surface, said adhesive composition having a sufficiently slow cure time to allow the tiles to be placed and aligned before cure;
aligning a first row of tiles along one edge of the substantially flat surface to be tiled;
using a tile spacer before the adhesive has cured to create a space of predetermined size between adjacent tiles and to align as many as four adjacent tiles with respect to each other, said tile spacer comprising a spacer body and a handle extending upwards from said spacer body, said spacer body formed in the shape of a cross of predetermined thickness made from a material sufficiently rigid to prevent substantial deformation by the tiles, said cross having a center and four arms extending outwardly from said center, each arm positioned at an angle of substantially ninety degrees from each adjacent arm, each said arm having a predetermined width for creating said space of predetermined size between adjacent tiles, each said arm having a bottom surface with a substantially flat portion for engaging the flat surface to be tiled with its adhesive layer, each said arm also having a first side surface extending upwards away from said bottom surface and a second side surface extending upwards away from an opposite end of said bottom surface, said first and second side surfaces having a substantially flat portion positioned in a plane which is perpendicular to said bottom surface for engaging and aligning facing edges of adjacent tiles;
allowing the adhesive composition to cure;
grasping the handle of each tile spacer and pulling upward to remove the tile spacer from between the tiles; and,
filling the space of predetermined size between the tiles with grout.

12. The method of claim 11 wherein an intersection between said bottom surface of each tile spacer arm and each arm side surface is beveled to enable each arm to slip easily into place past sharp edges of adjoining tiles.

13. The method of claim 11 wherein an intersection between each adjacent arm of said tile spacer is radiused to provide a concave surface for easily slipping the intersection over a sharp corner of a tile substantially without interference.

14. The method of claim 11 wherein said tile spacer is made from injection molded silicone whereby when the arms of said tile spacer are pushed between adjacent tiles they will not deform substantially but will force tiles which are too close together apart a sufficient distance so that the arm of the tile spacer will slide between the adjacent tiles to create the desired space of predetermined size.

15. The method of claim 11 wherein the tile spacer is color coded to denote the space of predetermined size which will be created by each arm of the tile spacer, and further including as a first step the step of determining the size of the space to be created between each adjacent tile and selecting the predetermined color tile spacer which will produce a space of that size.

16. A point of sale display for selling color coded tile spacers comprising:
a first container holding a plurality of first tile spacers comprising a spacer body and a handle extending upwards from said spacer body, said spacer body formed in the shape of a cross of predetermined thickness, said cross having a center and four arms extending outwardly from said center, each arm positioned at an angle of substantially ninety degrees from each adjacent arm, each said arm having a first predetermined width for creating a space of predetermined size between adjacent tiles in a tile installation, said first tile spacers having a first color which is visible to a consumer through said first container;
a second container holding a plurality of second tile spacers comprising a spacer body and a handle extending upwards from said spacer body, said spacer body formed in the shape of a cross of predetermined thickness, said cross having a center and four arms extending outwardly from said center, each arm positioned at an angle of substantially ninety degrees from each adjacent arm, each said arm having a second predetermined width for creating a space of predetermined size between adjacent tiles in a tile installation which is different from said first predetermined width of said first tile spacers, said second tile spacers having a second color which is visible to a consumer through said second container, said second color being visually distinguishable from said first color by a consumer; and,
a means for displaying a plurality of said first and second containers including identifying information to show the size of each color displayed whereby a consumer may select the size tile spacer desired by selecting the appropriate color.

17. A tile spacer for spacing tiles during construction of a tile floor or wall comprising:
a body in the form of a cross of predetermined thickness made from a material sufficiently rigid to prevent substantial deformation by the tiles, said cross having a center and four arms extending outwardly from said center, each arm positioned at an angle of substantially ninety degrees from each adjacent arm, each said arm having a predetermined width equal to a desired spacing between adjacent tiles, each said arm having a bottom surface for engaging the surface to be tiled, each said arm also having a first side surface extending upwards away from a first edge of said bottom surface at an angle of about 90 degrees and a second side surface extending upwards away from an opposite side of said bottom surface at an angle of about 90 degrees, said first and second side surfaces having a substantially flat portion for engaging and aligning an edge of a tile; and a groove connecting diagonally opposed intersections between adjacent arms through said center for forming a raised bead of predetermined shape in an adhesive layer in which the tiles are laid during the construction of the tile floor.

18. The spacer of claim 17 additionally including a means for inserting and removing the spacer body from between tiles.

19. The spacer of claim 18 wherein said means for removing the spacer body from between the tiles is a handle engaging said spacer body, said handle of sufficient size to be grasped by a user for inserting and removing the spacer between two or more tiles laid adjacent to one another.

20. The spacer of claim 18 wherein said handle is formed as a unitary structure on an upper surface of said spacer body.
